(19) United States
(12) Patent Application Publication
(10) Pub. No.: US 2026/0312386 A1
(43) Pub. Date: Oct. 8, 2026

(54) CABLE HANGER AND CABLE MANAGEMENT SYSTEM INCLUDING SAME

(71) Applicant: Cambria County Association for the Blind & Handicapped, Johnstown, PA (US)

(72) Inventor: JASON RICHARD MARTINAGE, South Fork, PA (US)

(73) Assignee: Cambria County Association for the Blind & Handicapped, Johnstown, PA (US)

(21) Appl. No.: 19/638,401

(22) Filed: Apr. 3, 2026

Related U.S. Application Data
(60) Provisional application No. 63/783,371, filed on Apr. 4, 2025.

(51) Int. Cl. H02G 3/04; F16L 3/02

(52) U.S. Cl. CPC H02G 3/0456; F16L 3/02

(57) ABSTRACT

A cable hanger arrangement for use in supporting a plurality of pairs of electrical cables from a messenger wire in a spaced configuration includes an attachment arrangement for engaging with the messenger wire in a manner such that the cable hanger arrangement is suspended from the messenger wire. The cable hanger arrangement also includes a plurality of carrier portions, each carrier portion being structured to support a respective pair of electrical cables of the plurality of pairs. The plurality of carrier portions are disposed in a spaced array having a plurality of rows, and at least a first row of the plurality of rows has a greater quantity of carrier portions than a second row of the plurality of rows above the at least first row.

### CROSS REFERENCE TO RELATED APPLICATIONS

This application claims priority to U.S. Provisional Patent Application Serial No. 63/783,371, filed on Apr. 4, 2025, titled “CABLE HANGER AND CABLE MANAGEMENT SYSTEM INCLUDING SAME”, the disclosure of which is incorporated herein by reference.

### FIELD

The disclosed concept relates generally to cable hangers for managing cables. More particularly, the disclosed concept relates to cable hangers for hanging on a messenger wire and supporting/managing cables strung along generally the same route as the messenger wire. Even more particularly, the disclosed concept relates to cable hangers for use in supporting/managing electrical cables, such as DC power cables, associated with solar power generating arrangements.

### BACKGROUND

There are many environments/situations in which cables, such as those used to convey electrical current, need to be strung/supported in an organized manner. For example, in large-scale solar power plants, various quantities of cables, such as DC power cables (typically in pairs), are utilized to convey electrical current generated by solar panels from the solar panels to production and/or transmission equipment within the plant. Other cables conveying current and/or signal data to/from various equipment are also commonly utilized. U.S. Patent Nos. 9,722,405 and 10,177,551 (commonly assigned to the Applicant herein), the contents of which are incorporated by reference herein, describe some examples of above-ground arrangements that have been utilized to manage/support/organize cables used in solar power plants. U.S. Publication No. US 2025/0043888 (also commonly assigned), the contents of which are incorporated by reference herein, describe cable arrangements which space cables apart to provide for cooling of the cables and thus reduce/eliminate need for derating of cables which would otherwise be necessitated by internal heating. While such solutions have greatly improved upon previous solutions, there is still room for improvement.

### SUMMARY

Embodiments of the disclosed concept improve upon conventional arrangements. As one embodiment, a cable hanger arrangement for use in supporting a plurality of pairs of electrical cables from a messenger wire in a spaced configuration is provided. The cable hanger arrangement comprises: an attachment arrangement structured to be engaged with the messenger wire in a manner such that the cable hanger arrangement is suspended from the messenger wire; and a plurality of carrier portions, each carrier portion being structured to support a respective pair of electrical cables of the plurality of pairs, wherein the plurality of carrier portions are disposed in a spaced array having a plurality of rows, and wherein at least a first row of the plurality of rows has a greater quantity of carrier portions than a second row of the plurality of rows above the at least first row.

At least a third row of the plurality of rows disposed below the first row and the second row may have a greater quantity of carrier portions than the first row.

Each carrier portion may be sized and configured so as to support the respective pair of electrical cables in a stacked configuration. The pair of electrical cables may comprise a pair of DC power cables, each of at least 250 kcmil in size.

The attachment arrangement may comprise at least one hook member structured to hook around the messenger wire.

The attachment arrangement may comprise a pair of overlapping hook members that are each structured to hook around the messenger wire.

The cable hanger arrangement may further comprise: a primary hanger including the attachment arrangement structured to be engaged with the messenger wire; and a secondary hanger coupled to the primary hanger by a number of connection elements, wherein the primary hanger comprises a first quantity of the plurality of carrier portions, and wherein the secondary hanger comprises a second quantity of the plurality of carrier portions greater than the first quantity. The primary hanger may have a first overall width and the secondary hanger may have a second overall width greater than the first overall width. The number of connection elements may comprise a plurality of hook members. The secondary hanger may be a first secondary hanger, the cable hanger arrangement may further comprise a second secondary hanger coupled to the first secondary hanger by a number of further connection elements, and the second secondary hanger may comprise a third quantity of the plurality of carrier portions the same as the second quantity. The secondary hanger may be a first secondary hanger, the cable hanger arrangement may further comprise a second secondary hanger coupled to the first secondary hanger by a number of further connection elements, and the second secondary hanger may comprise a third quantity of the plurality of carrier portions greater than the second quantity. The primary hanger may have a first overall width, the first secondary hanger may have a second overall width greater than the first overall width, and the second secondary hanger may have a third overall width greater than the second overall width.

The cable hanger may be formed from a high tensile strength wire.

As another embodiment, a cable management system for use in managing a plurality of pairs of electrical cables is provided. The cable management system comprises: a messenger wire structured to be suspended a distance above the ground; and a plurality of cable hanger arrangements such as those previously discussed.

As yet a further embodiment, a method of organizing a plurality of DC power cables is provided. The method comprises: suspending a plurality of cable hanger arrangements such as those previously discussed along a messenger wire provided a distance in the air; and placing a plurality of pairs of the DC power cables in respective carrier portions of each cable hanger arrangement of the plurality of cable hanger arrangements.

Such improvements and other objects, features, and characteristics of the disclosed concept, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are provided for the purpose of illustration and description only and are not intended as a definition of the limits of the disclosed concept.

### BRIEF DESCRIPTION OF THE DRAWINGS

A full understanding of the invention can be gained from the following description of the preferred embodiments when read in conjunction with the accompanying drawings in which:

FIG. 1 is a perspective view of two cable hanger arrangements in accordance with an example embodiment of the disclosed concept shown arranged along a messenger wire forming a cable management system in accordance with an example embodiment of the disclosed concept;

FIG. 2 is a front elevation view of one of the cable hanger arrangements of FIG. 1 shown positioned on a messenger wire suspended from piers supporting solar panels;

FIG. 3 is another elevation view of the cable hanger arrangement of FIG. 2, shown with nine pairs of electrical cables (shown schematically) positioned thereon;

FIG. 4 is a perspective view of the cable hanger arrangement of FIG. 2 shown, similar to FIG. 3, with nine pairs of electrical cables positioned thereon;

FIG. 5 is a side elevation view of the cable hanger arrangement of FIG. 2;

FIG. 6 is another side elevation view of the cable hanger arrangement of FIG. 2 shown, similar to FIGS. 3 and 4, with pairs of electrical cables positioned thereon;

FIG. 7 is an elevation view of an arrangement in accordance with an example embodiment of the disclosed concept showing two cable hanger arrangements, such as those shown in FIGS. 1-6, with each cable hanger arrangement positioned on a messenger wire suspended from piers supporting solar panels as well as the solar panels positioned adjacent to the hanger arrangements;

FIG. 8 is an elevation view of a cable hanger arrangement in accordance with a further example embodiment of the disclosed concept shown positioned on a messenger wire suspended from piers supporting solar panels;

FIG. 9 is an elevation view of a cable hanger arrangement in accordance with another example embodiment of the disclosed concept shown positioned on a messenger wire suspended from piers supporting solar panels;

FIG. 10 is another elevation view of the cable hanger arrangement of FIG. 9, shown with seven pairs of electrical cables (shown schematically) positioned thereon;

FIG. 11 is a perspective view of the cable hanger arrangement of FIG. 9;

FIG. 12 is another perspective view of the cable hanger arrangement of FIG. 9 shown, similar to FIG. 10, with seven pairs of electrical cables positioned thereon;

FIG. 13 is a side elevation view of the cable hanger arrangement of FIG. 9;

FIG. 14 is another side elevation view of the cable hanger arrangement of FIG. 9 shown, similar to FIGS. 10 and 12, with pairs of electrical cables positioned thereon;

FIG. 15 is an elevation view of a cable hanger arrangement in accordance with yet another example embodiment of the disclosed concept shown positioned on a messenger wire suspended from piers supporting solar panels;

FIG. 16 is another elevation view of the cable hanger arrangement of FIG. 15, shown with eight pairs of electrical cables (shown schematically) positioned thereon;

FIG. 17 is a perspective view of the cable hanger arrangement of FIG. 15;

FIG. 18 is another perspective view of the cable hanger arrangement of FIG. 15 shown, similar to FIG. 16, with eight pairs of electrical cables positioned thereon;

FIG. 19 is a side elevation view of the cable hanger arrangement of FIG. 15; and

FIG. 20 is another side elevation view of the cable hanger arrangement of FIG. 15 shown, similar to FIGS. 16 and 18, with pairs of electrical cables positioned thereon.

### DETAILED DESCRIPTION OF THE PREFERRED EMBODIMENTS

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, and as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components.

As used herein, the term “number” shall mean one or an integer greater than one (i.e., a plurality). Thus, for example, a “number of elements” means one element or a plurality of elements.

Embodiments of the disclosed concept provide solutions for managing electrical cables, such as DC power cables employed in solar power generation, in a manner which spaces the cables so as to minimize heating effects resulting from adjacent cables and allows for the elimination of cable derating. By minimizing such effects, smaller, easier to maneuver, less costly cables can be employed in a particular installation as compared to arrangements wherein such heating effects are not addressed. Additionally, embodiments of the disclosed concept provide such solutions in arrangements that allow for the solar panels to be selectively positioned at steep angles, such as positioned in some systems during hail storms so as to minimize damage to the solar panels, while keeping the cables desirably at high locations relative to the ground (so as to minimize potential interference with animals and/or other ground-based elements).

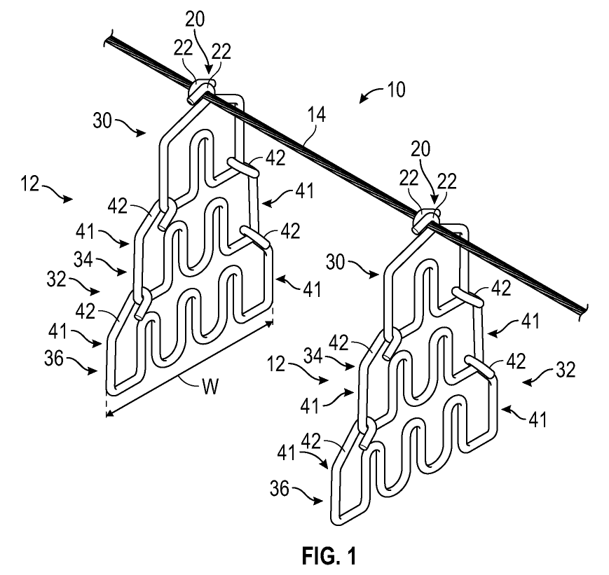

A perspective view of a cable management system 10 in accordance with an example embodiment of the disclosed concept is shown in FIG. 1. System 10 includes a plurality of cable hanger arrangements 12 (two are shown in such example) that are each suspended/hanging from a messenger wire 14 that itself is suspended a distance above the ground. In an example embodiment of the disclosed concept in which system 10 is employed in a solar power plant, messenger wire 14 may be strung a distance above the ground between piers or other suitable structures supporting the solar panels or other arrangements of the solar power plant. Depending on the application, messenger wire 14 may be a multifunction line, e.g., such as described in previously mentioned U.S. Patent No. 10,177,551, and thus composed of suitable materials to be utilized as a ground wire in addition to supporting hanger arrangements 12 without varying from the scope of the disclosed concept.

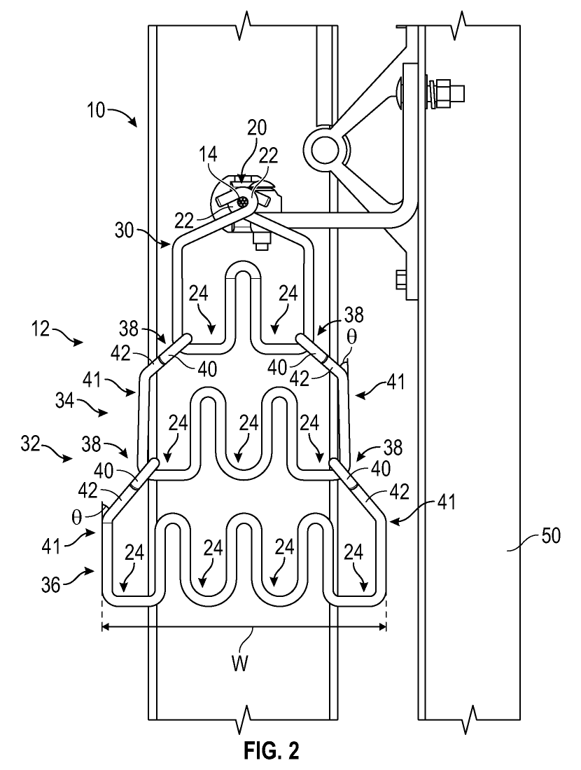

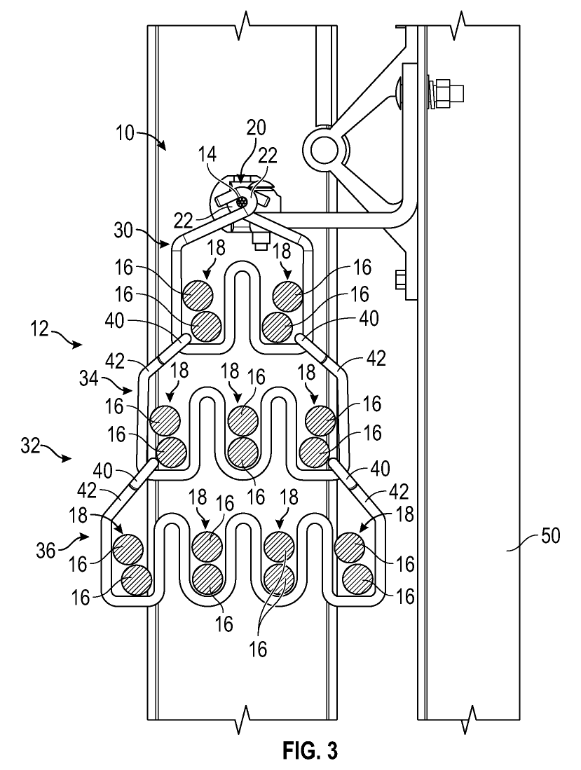

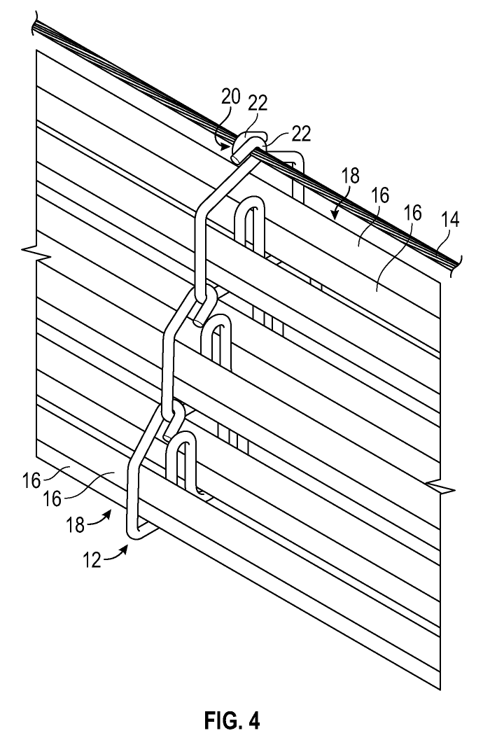

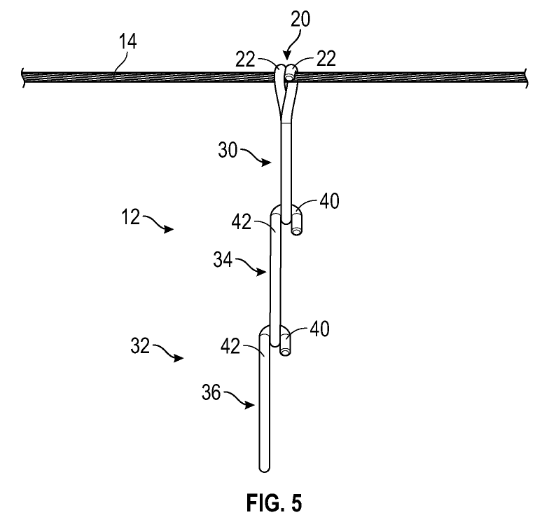

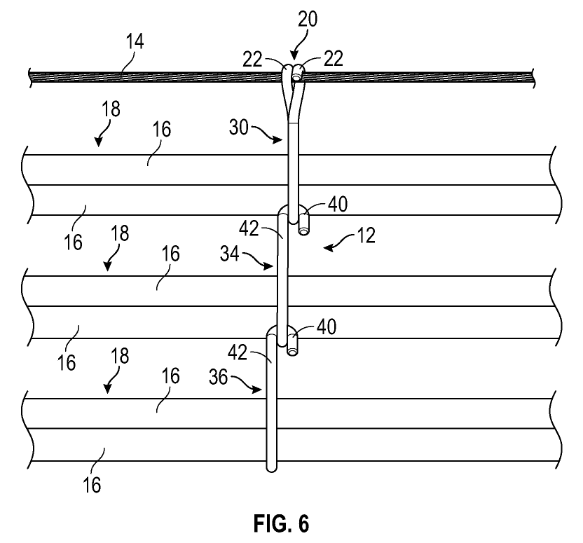

Continuing to refer to FIG. 1 and additionally FIGS. 2-6, each of cable hanger arrangements 12 is structured to manage (i.e., hold/support) a plurality of electrical cables 16 (e.g., see FIGS. 3 and 4) in a predetermined arrangement manner. In such example, electrical cables 16 are 500 kcmil DC power cables such as those commonly employed in solar power generation, however, it is to be appreciated that cables of other type or size (e.g., without limitation, 250 kcmil, 350 kcmil, 600 kcmil, 750 kcmil, and 1000 kcmil) may be supported without varying from the scope of the disclosed concept. In such example, electrical cables 16 are arranged in pairs 18.

Continuing to refer to FIGS. 1-6, each cable hanger arrangement 12 generally includes an attachment arrangement 20 structured to be engaged with the messenger wire 14 in a manner such that the cable hanger arrangement 12 may be hung/suspended from and/or coupled to the messenger wire 14. In some example embodiments of the disclosed concept, one or more hook members 22 structured to hook around messenger wire 14 have been employed for attachment arrangement 20. For example, in the embodiment shown in FIGS. 1-6, the attachment arrangement 20 includes two hook portions 22 that hook in generally opposite directions about messenger wire 14, thus together completely encircling messenger wire 14 and coupling the cable hanger arrangement 12 thereto. However, it is to be appreciated that other suitable arrangements may be employed for attaching/coupling cable hanger arrangement 12 with messenger wire 14 without varying from the scope of the disclosed concept.

Each cable hanger arrangement 12 further includes a plurality of carrier portions 24 (FIG. 2), with each carrier portion 24 being structured to support a respective pair 18 of the plurality of electrical cables 16. In such example, each carrier portion 24 is sized and configured so as to support the respective pair 18 of electrical cables 16 in a stacked configuration. As used herein, the phrase “stacked configuration” means an arrangement wherein two cables 16 are placed one on top of the other such that the center of the top cable 16 overlies at least a portion of the bottom cable 16 when such cables 16 are viewed axially in cross-section (e.g., see FIG. 3). It is to be appreciated that in such example each carrier portion 24 is sized and configured to carry therein only two cables 16, such as two of the DC cables of one or more of the sizes previously discussed. It is also to be appreciated that while the example embodiments discussed herein employ carrier portions 24 that are generally u-shaped and rectangular shaped, it is to be appreciated that carrier portions 24 of only one of such shapes and/or of one or more other shapes may be employed without varying from the scope of the disclosed concept.

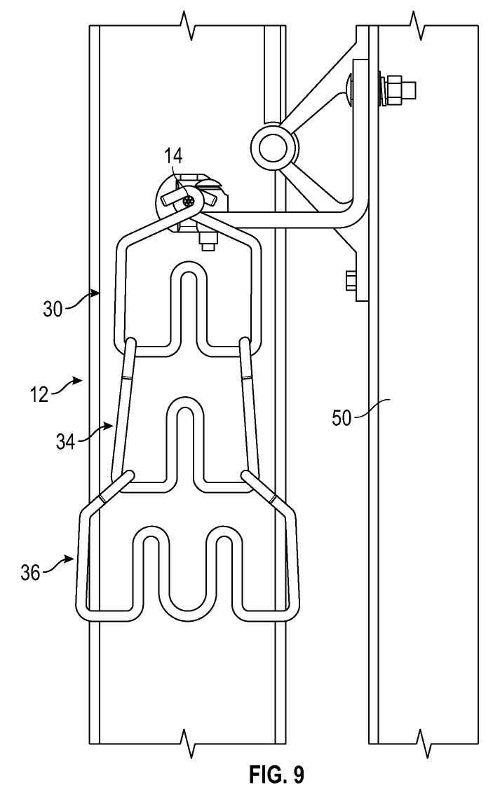

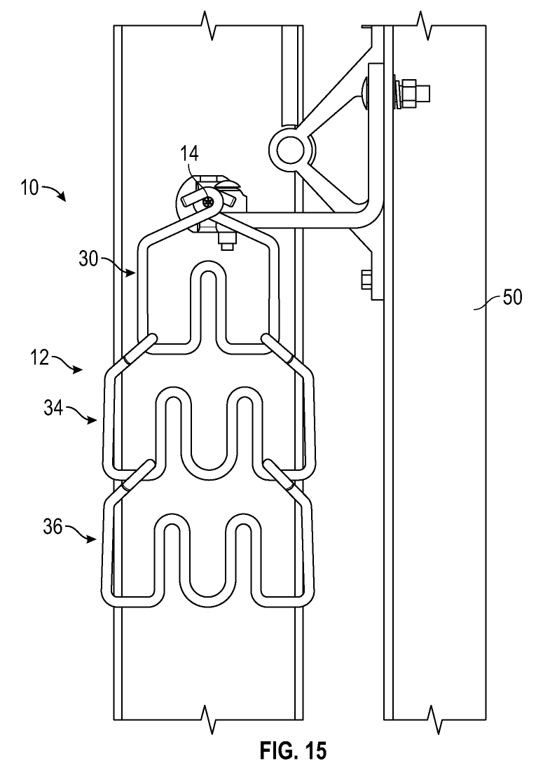

In the example embodiment shown in FIGS. 1-6, the plurality of carrier portions 24 are disposed in a spaced array. As used herein, the phrase “spaced array” means an arrangement wherein the arrayed items (e.g., carrier portions 24 and thus the pairs 18 of cables 16 disposed therein) are positioned generally in vertical columns and horizontal rows (when a hanger arrangement 12 is suspended from a messenger wire 14) so as to have predetermined gaps or air spaces between adjacent items so as to provide for dissipation of possible heat from the cables 16 created due to the passage of current therethrough. By providing for such heat dissipation, cable derating, such as necessitated in many conventional arrangements, may be avoided, and thus smaller sized cables 16 may be employed for carrying a given current as compared to cables 16 that are bunched together. In the example embodiment shown in FIGS. 1-6, the quantity of carrier portions 24 in each row increases from row to row moving from the top row to the bottom (e.g., two carrier portions 24 in the top row, three in the second row, and four in the bottom row) thus resulting in hanger arrangement 12 having a generally triangular outer shape (as best shown in FIGS. 3 and 4). It is to be appreciated, however, that other arrangements in which the quantity of carrier portions 24 of adjacent rows are the same may also be employed without varying from the scope of the disclosed concept as long as at least one adjacent lower row of carrier portions 24 of the hanger arrangement 12 is greater than the adjacent row of carrier portions 24 immediately above (e.g., without limitation, see the hanger arrangements 12 of FIGS. 9 and 15).

In the example embodiment shown in FIGS. 1-6, each cable hanger arrangement 12 is of modular construction and includes a primary hanger 30 and a number of secondary hangers 32, with each hanger 30, 32 including a respective row of the carrier portions 24 of the spaced array previously discussed. Primary hanger 30 directly engages messenger wire 14. In such example, primary hanger 30 may be engaged with/coupled to messenger wire 14 by first hooking one of previously described hook members 22 about messenger wire 14 and then subsequently slightly bending/contorting primary hanger 14 such that the other hook member 22 hooks about messenger wire 14. Such process is simply reversed if removal of primary hanger 30 from messenger wire 14 is desired.

Each secondary hanger 32 is selectively coupled, directly or indirectly, to primary hanger 30 by a number of connection elements 38. In the illustrated example, cable hanger 12 includes a first secondary hanger 34 directly coupled to primary hanger 30, and a second secondary hanger 36 indirectly coupled to primary hanger 30 via the first secondary hanger 34 to which the second secondary hanger 36 is directly coupled. In such example, each secondary hanger 32 includes a pair of connection elements 38 in the form of hook members 40 positioned to hook about another hanger (i.e., connection elements 38 of first secondary hanger 34 hook about portions of primary hanger 30, while connection elements 38 of second secondary hanger 36 hook about portions of first secondary hanger 34). It is to be appreciated that one or more of the quantity of secondary hangers 32 (e.g., quantities greater than two secondary hangers 32 coupled to a messenger wire 14 via a primary hanger 30 may be employed although not illustrated herein), attachment arrangement 20, connection elements 38, and/or sizing of the secondary hangers 32 may be varied without varying from the scope of the disclosed concept.

In the example shown in FIGS. 1-6, each subsequent secondary hanger 32 (e.g., 32, 34) is of a greater overall width w (perpendicular to messenger wire 14) and includes a greater quantity of carrier portions 24 than the hanger immediately above. To provide for such greater overall width w and increasing quantity of carrier portions 24, each of secondary hangers 34 and 36 include arms 41 having at least an angled portion 42 thereof, with each arm 41 ending at a respective connection element 38 (e.g., hook member 40). In the examples illustrated herein, each angled portion 42 is angled at an angle Ɵ of about 45 degrees from vertical, however, it is to be appreciated that such angle Ɵ may be varied depending on the particular application without varying from the scope of the disclosed concept. Further, in such example, each of primary hanger 30 and secondary hangers 34 and 36 are formed from a formed metal wire that was subsequently coated (e.g., similar to the construction described in commonly assigned U.S. Patent No. 9,722,405) however, it is to be appreciated that one or more of the fabrication/construction of cable hanger arrangement 12 and/or hangers 30, 34, 36 may be varied, as well as the presence (or lack thereof) of any coating or coatings thereon may be varied without varying from the scope of the disclosed concept.

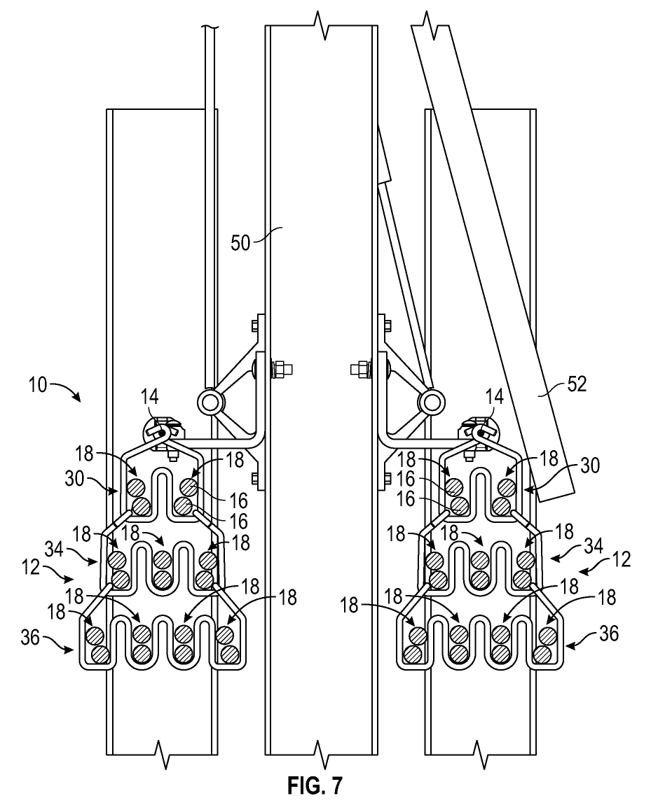

As previously discussed, and illustrated in FIG. 7, when suspended adjacent piers 50 and movable solar panels 52, cable hanger arrangement 12 provides for the solar panels 52 to be positioned at steep angles (such as positioned in some systems during hail storms to minimize damage to panels), while keeping the pairs 18 of cables 16 desirably at high locations relative to the ground. More particularly, as shown in the example embodiment of FIG. 7, such arrangement provides for the messenger wire 14 and the primary hanger 30 coupled directly thereto to be positioned at a height such that the majority of the hanger 30 is disposed above a bottom edge of the solar panels 52 without inhibiting the ability of the panels 52 to be disposed at such steep angle. Meanwhile, the secondary hangers 34 and 36 with their increasing quantities of carrier portions 24 provide for the hanger arrangement 12 to still carry a suitable overall quantity of pairs 18 of electrical cables 16 at a suitable height above the ground.

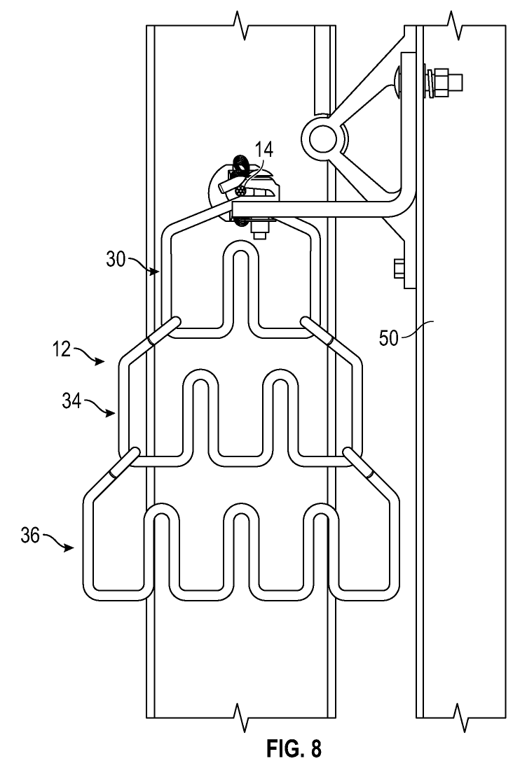

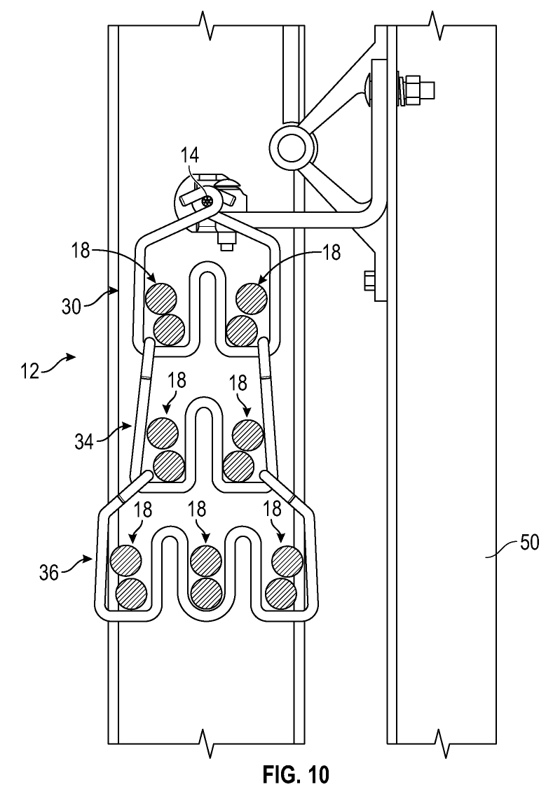

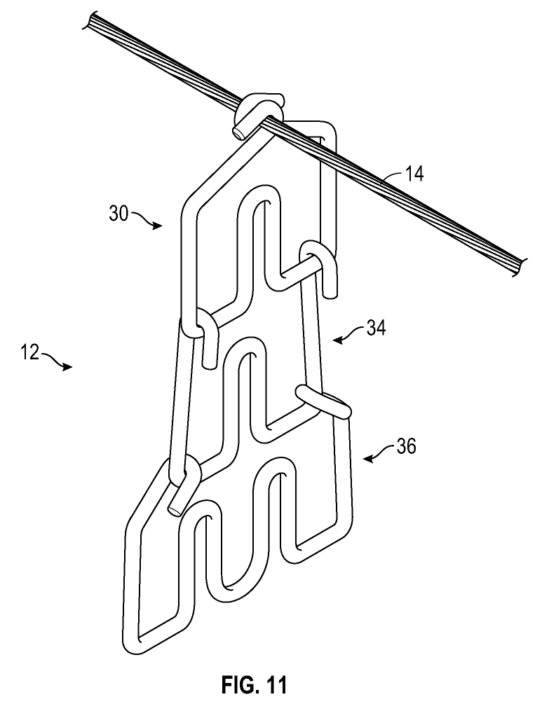

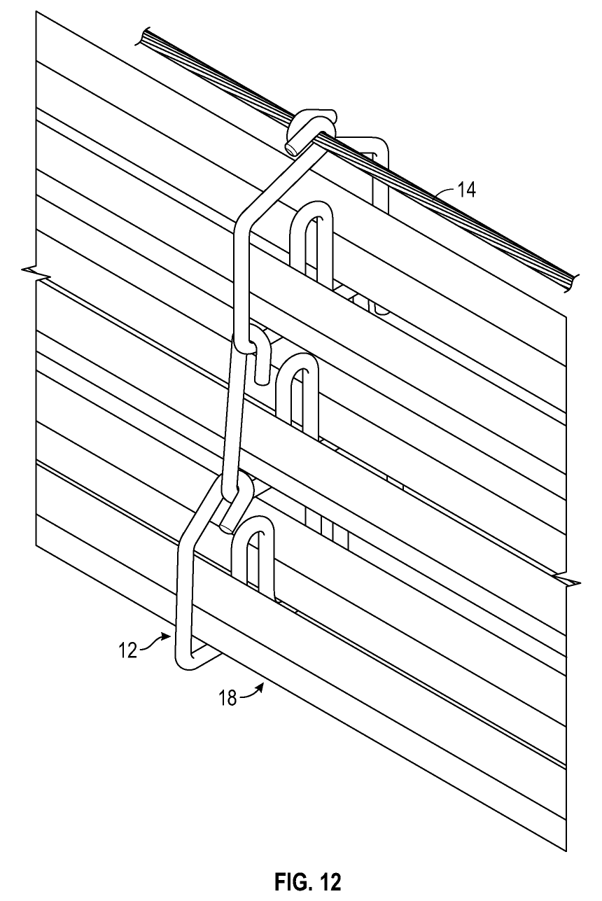

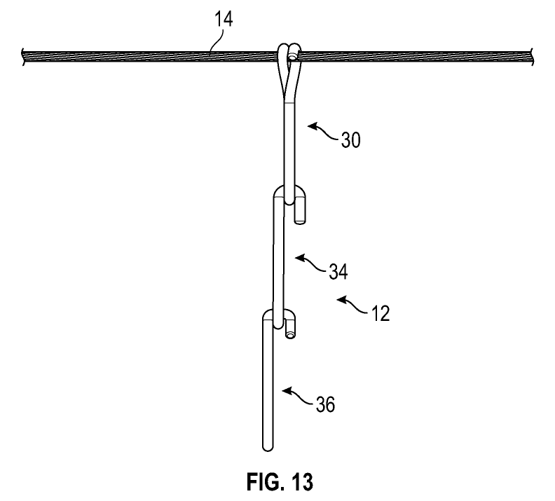

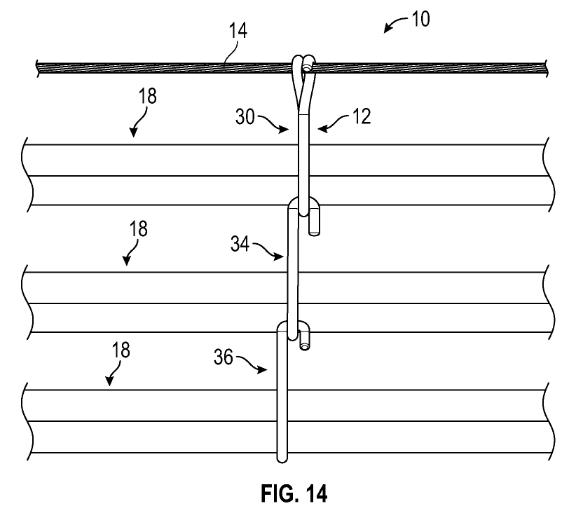

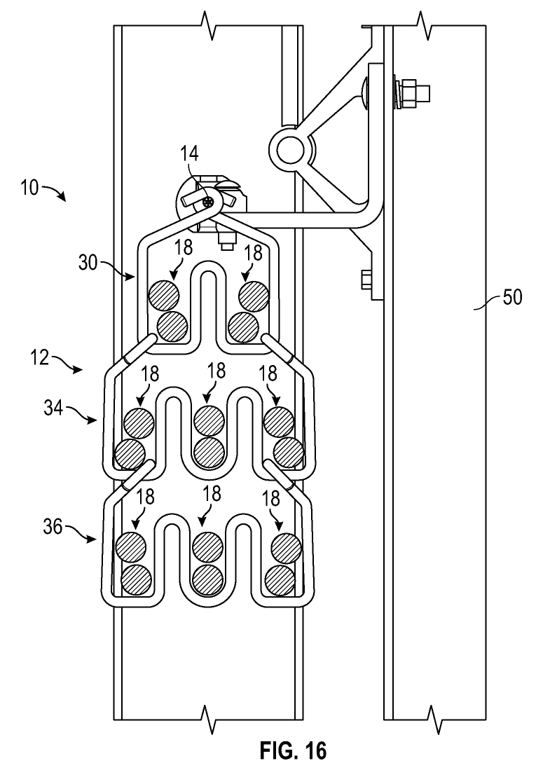

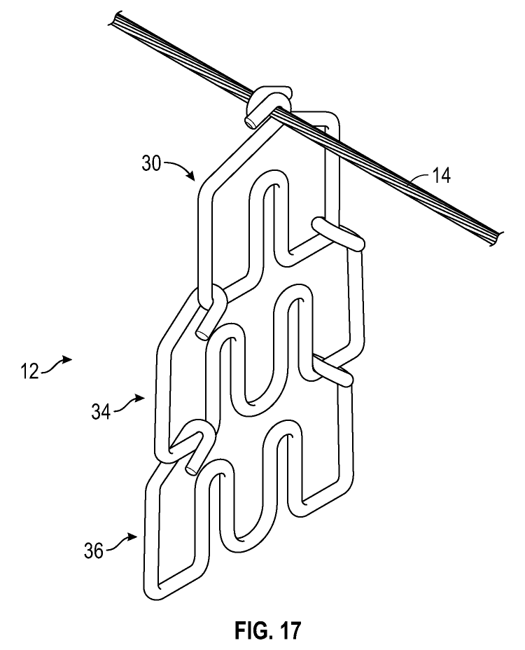

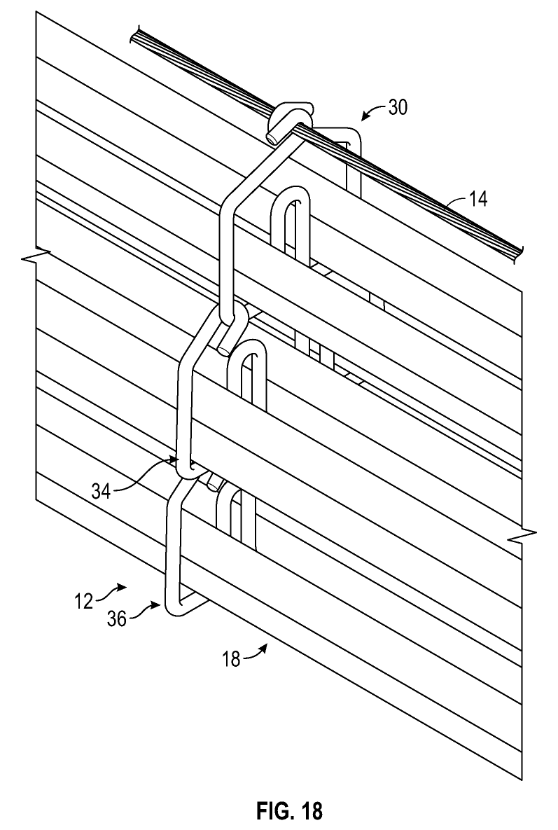

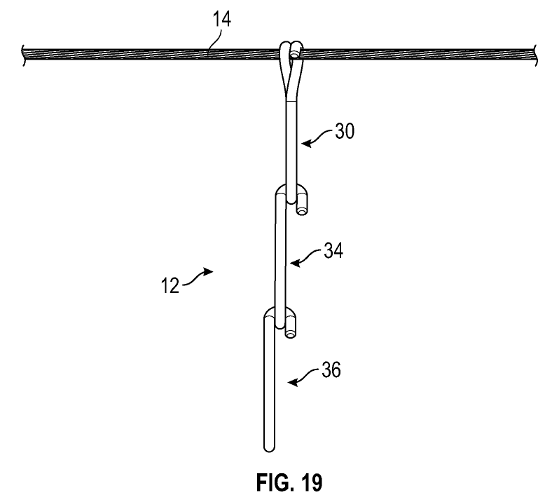

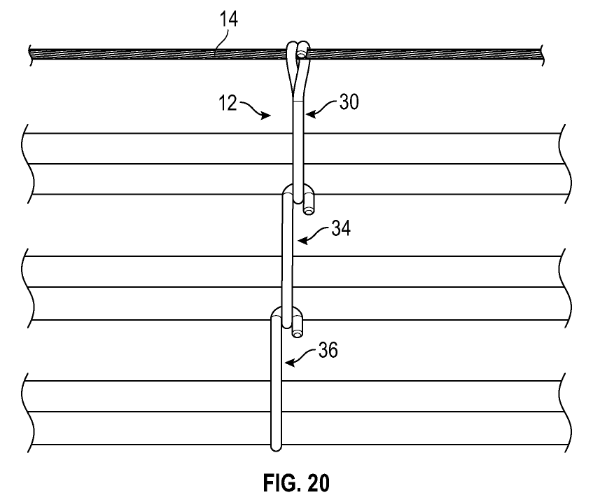

FIGS. 8-20 illustrate further examples of embodiments of hanger arrangements in accordance with the disclosed concept. From such examples, it is to be readily appreciated that embodiments of the disclosed concept provide for customizable arrangements for positioning cables adjacent solar panels that can position the cables in tight spaces while keeping the cables spaced so as to avoid the need for derating of the cables and without interfering with movement of the panels.

Installation of cables 16 within hanger arrangements 12 such as described herein are generally similar to such methods described in U.S. Publication No. US 2025/0043888 which has been incorporated herein by reference and thus are not otherwise described in further detail herein.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

From the foregoing it can thus be readily appreciated that embodiments of the disclosed concept provide cable management solutions which readily provide controlled, predetermined spacing for cables, and cable pairs in installations such as those commonly encountered in solar power generation and related fields.

In the claims, any reference signs placed between parentheses shall not be construed as limiting the claim. The word “comprising” or “including” does not exclude the presence of elements or steps other than those listed in a claim. In any device claim enumerating several means, several of these means may be embodied by one and the same item of hardware. The word “a” or “an” preceding an element does not exclude the presence of a plurality of such elements. The mere fact that certain elements are recited in mutually different dependent claims does not indicate that these elements cannot be used in combination.

What is claimed is:

1. A cable hanger arrangement for use in supporting a plurality of pairs of electrical cables from a messenger wire in a spaced configuration, the cable hanger arrangement comprising:
an attachment arrangement structured to be engaged with the messenger wire in a manner such that the cable hanger arrangement is suspended from the messenger wire; and
a plurality of carrier portions, each carrier portion being structured to support a respective pair of electrical cables of the plurality of pairs,
wherein the plurality of carrier portions are disposed in a spaced array having a plurality of rows, and
wherein at least a first row of the plurality of rows has a greater quantity of carrier portions than a second row of the plurality of rows above the at least first row.

2. The cable hanger arrangement of claim 1, wherein at least a third row of the plurality of rows disposed below the first row and the second row has a greater quantity of carrier portions than the first row.

3. The cable hanger arrangement of claim 1, wherein each carrier portion is sized and configured so as to support the respective pair of electrical cables in a stacked configuration.

4. The cable hanger arrangement of claim 3, wherein the pair of electrical cables comprise a pair of DC power cables, each of at least 250 kcmil in size.

5. The cable hanger arrangement of claim 1, wherein the attachment arrangement comprises at least one hook member structured to hook around the messenger wire.

6. The cable hanger arrangement of claim 1, wherein the attachment arrangement comprises a pair of overlapping hook members that are each structured to hook around the messenger wire.

7. The cable hanger arrangement of claim 1, further comprising:
a primary hanger including the attachment arrangement structured to be engaged with the messenger wire; and
a secondary hanger coupled to the primary hanger by a number of connection elements,
wherein the primary hanger comprises a first quantity of the plurality of carrier portions, and
wherein the secondary hanger comprises a second quantity of the plurality of carrier portions greater than the first quantity.

8. The cable hanger arrangement of claim 7, wherein the primary hanger has a first overall width and wherein the secondary hanger has a second overall width greater than the first overall width.

9. The cable hanger arrangement of claim 7, wherein the number of connection elements comprises a plurality of hook members.

10. The cable hanger arrangement of claim 7, wherein the secondary hanger is a first secondary hanger, wherein the cable hanger arrangement further comprises a second secondary hanger coupled to the first secondary hanger by a number of further connection elements, and wherein the second secondary hanger comprises a third quantity of the plurality of carrier portions the same as the second quantity.

11. The cable hanger arrangement of claim 7, wherein the secondary hanger is a first secondary hanger, wherein the cable hanger arrangement further comprises a second secondary hanger coupled to the first secondary hanger by a number of further connection elements, and wherein the second secondary hanger comprises a third quantity of the plurality of carrier portions greater than the second quantity.

12. The cable hanger arrangement of claim 11, wherein the primary hanger has a first overall width, wherein the first secondary hanger has a second overall width greater than the first overall width, and wherein the second secondary hanger has a third overall width greater than the second overall width.

13. The cable hanger arrangement of claim 1, wherein the cable hanger is formed from a high tensile strength wire.

14. A cable management system for use in managing a plurality of pairs of electrical cables, the cable management system comprising:
a messenger wire structured to be suspended a distance above the ground; and
a plurality of cable hanger arrangements, each cable hanger arrangement comprising:
an attachment arrangement structured to be engaged with the messenger wire in a manner such that the cable hanger is suspended from the messenger wire; and
a plurality of carrier portions, each carrier portion being structured to support a respective pair of electrical cables of the plurality of pairs,
wherein the plurality of carrier portions are disposed in a spaced array having a plurality of rows, and
wherein at least a first row of the plurality of rows has a greater quantity of carrier portions than a second row of the plurality of rows above the at least first row.

15. The cable management system of claim 14, wherein, for each cable hanger arrangement, at least a third row of the plurality of rows disposed below the first row and the second row has a greater quantity of carrier portions than the first row.

16. The cable management system of claim 14, wherein each cable hanger arrangement further comprises:
a primary hanger including the attachment arrangement structured to be engaged with the messenger wire; and
a secondary hanger coupled to the primary hanger by a number of connection elements,
wherein the primary hanger comprises a first quantity of the plurality of carrier portions, and
wherein the secondary hanger comprises a second quantity of the plurality of carrier portions greater than the first quantity.

17. The cable management system of claim 16, wherein the primary hanger has a first overall width and wherein the secondary hanger has a second overall width greater than the first overall width.

18. The cable management system of claim 16, wherein the secondary hanger is a first secondary hanger, wherein the cable hanger arrangement further comprises a second secondary hanger coupled to the first secondary hanger by a number of further connection elements, and wherein the second secondary hanger comprises a third quantity of the plurality of carrier portions greater than the second quantity.

19. A method of organizing a plurality of DC power cables comprising:
suspending a plurality of cable hanger arrangements along a messenger wire provided a distance in the air; and
placing a plurality of pairs of the DC power cables in respective carrier portions of each cable hanger arrangement of the plurality of cable hanger arrangements,
wherein, for each cable hanger arrangement, the plurality of carrier portions are disposed in a spaced array having a plurality of rows, and at least a first row of the plurality of rows has a greater quantity of carrier portions than a second row of the plurality of rows above the at least first row.

20. The method of claim 19, wherein placing the plurality of pairs of the DC power cables in respective carrier portions of each cable hanger arrangement of the plurality of cable hanger arrangements comprises placing each pair of DC power cables in the respective carrier portion in a stacked configuration.
